(19) United States
(12) Patent Application Publication
(10) Pub. No.: US 2016/0005530 A1
(43) Pub. Date: Jan. 7, 2016

(54) INDUCTIVE COMPONENT FOR USE IN AN INTEGRATED CIRCUIT, A TRANSFORMER AND AN INDUCTOR FORMED AS PART OF AN INTEGRATED CIRCUIT

(71) Applicant: ANALOG DEVICES GLOBAL, HAMILTON (BM)

(72) Inventor: Jan Kubík, Raheen (IE)

(21) Appl. No.: 14/322,321

(22) Filed: Jul. 2, 2014

(51) Int. Cl. H01F 27/34; H01F 27/30

(52) U.S. Cl. CPC H01F 27/34; H01F 27/303

(57) ABSTRACT

Inductive components, such as transformers, can be improved by the inclusion of a magnetic core. However the benefit of having a core is lost if the core enters magnetic saturation. One way to avoid saturation is to provide a bigger core, but this is costly in the context of integrated electronic circuits. The inventor realized that the flux magnetic flux density varies with position in a magnetic core within an integrated circuit, causing parts of the magnetic core to saturate earlier than other parts. This reduces the ultimate performance of the magnetic core. This disclosure provides structures that delay the onset of early saturation, enabling a transformer to handle more power.

### FIELD

The present disclosure relates to an improved inductor or improved transformer fabricated using microelectronic techniques, and to integrated circuits including such an inductive component.

### BACKGROUND

It is known that magnetic components, such as inductors and transformers have many uses. For example inductors may be used in the fabrication of filters and resonant circuits, or may be used in switched mode power converters to boost or reduce an input voltage for generation of a different output voltage. Transformers may be used in the transfer of power or signals from one circuit to another while providing high levels of galvanic isolation.

Inductors and transformers can be fabricated within an integrated circuit environment. For example it is known that spaced apart conductors generally forming a spiral or an approximation of a spiral can be formed on or within a semiconductor substrate to form a coil as part of an inductor or a transformer. Such spaced apart spiral inductors can be placed side by side or in a stacked configuration.

It is also possible to form a “coil” around a ferromagnetic core within an integrated circuit. However such an arrangement exhibits non-linearities in its behavior. It would be beneficial to provide an improved component within an integrated circuit.

### SUMMARY

According to a first aspect of the present disclosure there is provided an inductive component for use in an integrated circuit. The inductive component comprises: a magnetic core; a plurality of conductors arranged on a first side of the magnetic core; and a plurality of conductors arranged on a second side of the magnetic core. Each of the conductors on the first side and the second side of the magnetic core, which for simplicity may be regarded as being below and above the magnetic core, respectively, form sections of a coil that surrounds the core. A plurality of conductive connections connect conductors above the core to conductors below the core so as to form a first coil. The inductive component further comprises a compensation means, for example a compensation structure for compensating for saturation nonlinearity or non-uniformity.

It is thus possible to provide a magnetic component on or as part of an integrated circuit where the magnetic core saturates more uniformly. This in turn gives rise to greater linearity and improved power transfer within an operating region where substantially none of the core has reached magnetic saturation. This can be achieved without incurring an increased footprint for the magnetic component on a substrate, such as a semiconductor, on which the magnetic component is carried.

Advantageously, the plurality of conductors above and below the magnetic core are interconnected in such a way as to form first and second coils around the core in order to form a transformer.

The compensation structure may comprise varying a parameter of the first coil. The parameter may be a turns density of the first coil, which may be achieved by varying a pitch of the conductors as they traverse from one side of the coil to the other; a spacing between the conductors; or a width of the conductors. Two or more of parameters may be varied in combination. Where the inductive component comprises a plurality of coils, for example because it is a transformer, then parameters of the second coil may also be varied as described above.

Advantageously, in an embodiment of this disclosure, a conductor width of the conductors forming the first coil increases with increasing distance from an end of the magnetic core, and preferably from both ends of the magnetic core. This arrangement has the advantage of reducing the effective turns density of the coil around sections of the magnetic core which are located away from the ends of the core, while at the same time avoiding unnecessary increase in the resistance of the coil.

Advantageously the magnetic core may be formed as a plurality of laminated sections of magnetically active material separated from one another by insulating regions. Advantageously the thickness and/or dielectric material provided between the plurality of layers of the magnetically functional material forming the core may be periodically or occasionally varied.

The shape of the magnetic core may be varied, for example to depart from a simple rectangular shape to one which has end portions of reduced width compared to a central region. This spatial variation in the shape of the magnetic core may be used to modify the magnetic field distribution within the core such that magnetic flux density within the core is more evenly distributed. Where the core is a laminated core, the shape of individual ones of the laminations may be varied in order to modify the distribution of flux density within the magnetic core.

Preferably the inductive component is formed on a substrate that carries other integrated circuit components. The substrate may be a semiconductor substrate, the most common example of which is silicon. However other substrates may be used and may be chosen for operation at high frequencies. Such a substrate may include glass, or other semiconductors such as germanium.

According to a second aspect of the present disclosure there is provided a method of forming a magnetic component comprising depositing a first plurality of conductors on a substrate; forming an insulator between and above the plurality of conductors; forming a magnetic core above the insulator; forming an insulating layer above the magnetic core; forming a plurality of conductors above the insulating layer; and forming electrical interconnections between the first plurality of conductors and the second plurality of the conductors in an interconnect pattern so as to form a coil around the magnetic core. At least one of the magnetic core or the winding is non-uniform. The non-uniformity may be achieved by varying a width or thickness of the magnetic core or a winding/turns density of the coil along a coil axis.

### BRIEF DESCRIPTION OF THE DRAWINGS

Embodiments of this disclosure will now be described, by way of non limiting example only, with reference to the accompanying drawings, in which:

FIG. 1 is a schematic illustration of a transformer formed within an integrated circuit;

FIG. 2 is a plan view of a center-tapped transformer within an integrated circuit;

FIG. 3 is a circuit diagram showing a circuit for measuring flux density as a function of coil current;

FIG. 4 shows a graph of flux density versus coil current for a typical transformer on an integrated circuit;

FIG. 5 is a graph of flux density versus coil current having straight line approximations to the response of the coil added thereto for the purposes of explaining the advantages of the present disclosure;

FIG. 6 is a graph representing turns density as a function of position along a coil axis for a coil surrounding a rectangular magnetic core:

FIG. 7 is a schematic view of the windings of a coil, suitable for use in an inductor or a transformer in accordance with the present disclosure;

FIG. 8 is a schematic cross section through a laminated magnetic core;

FIG. 9 is a schematic cross section through a device constituting an embodiment of this disclosure; and

FIG. 10 shows a further variation in which the profile of the core is modified.

### DETAILED DESCRIPTION OF EMBODIMENTS

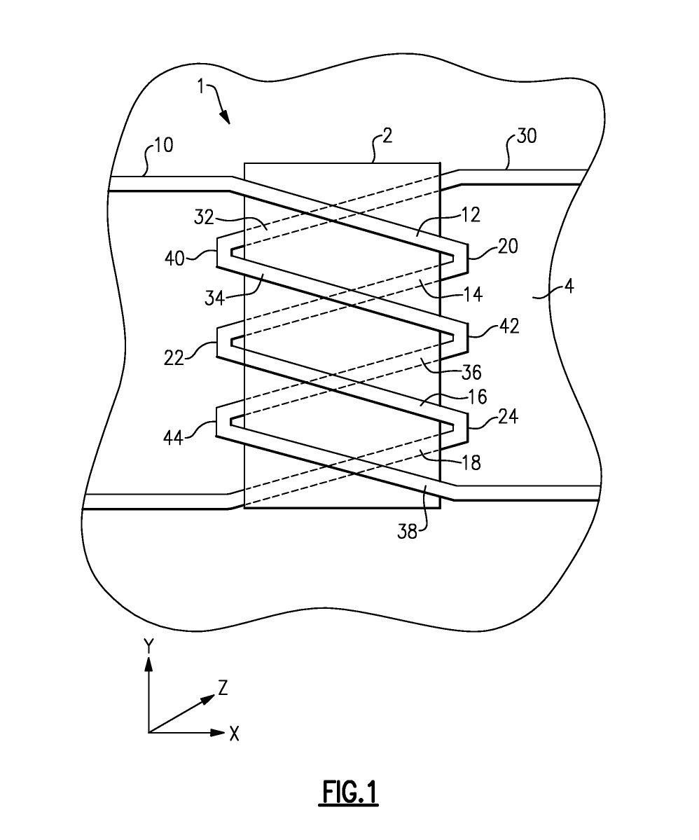

FIG. 1 schematically illustrates an example of a transformer 1 having a magnetic core, generally indicated by reference number 2, formed above a portion of a substrate 4. Advantageously the substrate 4 is a semiconductor substrate such that other components, such as drive circuitry and receiver circuitry associated with primary and secondary windings of the transformer 1, may be formed on the substrate 4 or on physically separate substrates within the same integrated circuit package. However, in some applications non-semiconductor substrate materials may be used for their electrical properties, such as higher impedance.

For the purposes of illustration, structures around the magnetic core 2 such as layers of insulating material, for example polyimide, have been omitted. Thus the only structures shown in FIG. 1 are the substrate 4, the magnetic core 2, and conductive tracks that provide a plurality of conductors formed in first and second layers on either side of the magnetic core 2 and parallel to the plane of the substrate 4 (and also parallel to the plane of FIG. 1). Thus the plurality of conductors exist above and below the magnetic core 2. The second layer of conductors can be considered as being above the magnetic core 2 and hence closer to the viewer than the first layer, which lies between the magnetic core 2 and the substrate 4. Conductors passing beneath the magnetic core 2 are shown in chain outline in FIG. 1, while conductors passing above the magnetic core 2 are shown in solid outline.

A first coil or winding, for example a primary winding 10, can be formed of linear track sections 12, 14, 16 and 18, where sections 12 and 16 are formed in the second metallic layer above the core 2, and sections 14 and 18 are formed in the first metallic layer below the core 2, and are connected together by way of vias or equivalent interconnect regions, 20, 22 and 24. A secondary winding 30 may be formed of planar track sections 32, 34, 36 and 38, where sections 34 and 38 are formed in the second metallic layer above the core 2, and sections 32 and 36 are formed in the first metallic layer below the core 2, and the sections are connected together by way of vias or other suitable interconnection components 40, 42 and 44. It can be seen that the primary and secondary coils are formed as structures that spiral around the magnetic core 2. The primary and secondary coils are insulated from the core 2, and are insulated from one another. Thus there is no galvanic path between the primary winding 10 and secondary winding 30, and the primary mechanism coupling the coils together is a magnetic one. Minor parasitic capacitances may also form signal flow paths between the primary and secondary winding, but these are considerably less significant. The Y-direction in FIG. 1 can also be considered the coil axis.

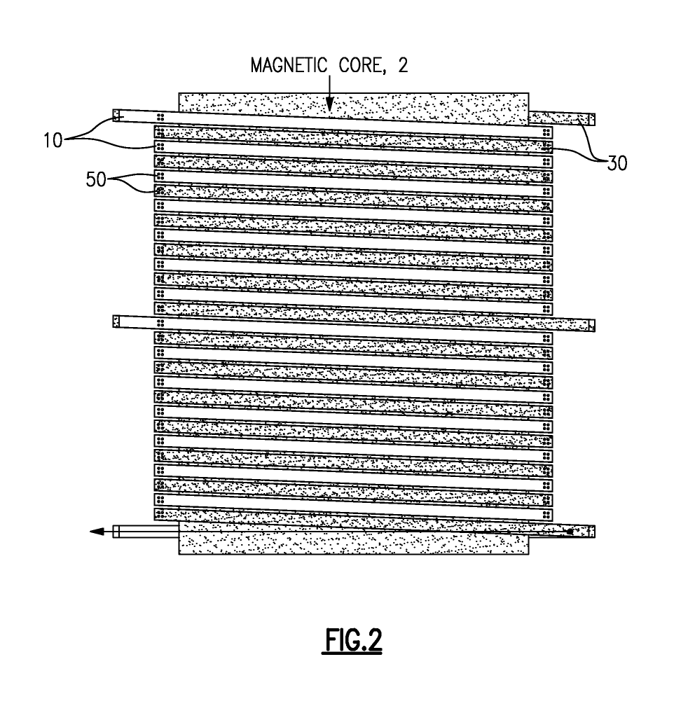

FIG. 2 shows a more realistic plan view of a transformer of the type shown in FIG. 1, but as might actually be formed on an integrated circuit. It can be seen that the primary winding 10 and the secondary winding 30 spiral their way around the magnetic core 2. Vias, generally designated 50, connect the conductors of the first layer with conductors of the second layer so as to form a planar approximation of a coil or winding encircling the magnetic core. The windings may also be center tapped, as illustrated in FIG. 2 by laterally extended tracks from the center of each coil. In the transformer shown in FIG. 2 the width of each conductor forming a winding is uniform, as is the space between adjacent windings or conductors in either of the layers of conductors. Generally speaking, the space between adjacent conductors in a layer is substantially minimized, consistent with reducing the ohmic resistance of the coil, while giving sufficient spacing between adjacent conductors to achieve a desired breakdown voltage between the coils of the transformer and to avoid shorting between coils as a result of manufacturing defects. The illustrated uniform windings can maximize the number of turns for a given occupied real estate.

Although a two winding transformer will be described, embodiments may have more than two windings. Also a single tapped winding may be used to form an autotransformer, or a single winding may be used to form an inductor.

When forming a device, such as a transformer, the saturation current, being the maximum current which can be passed through the primary winding of the transformer before magnetic core saturation occurs, is a critical property of the transformer and its ferromagnetic core and is linked to the total power rating of the transformer. Therefore maximizing the saturation current and the power transfer of a given size transformer are highly desirable.

It is known to the person skilled in the art that the magnetic flux density in the magnetic core of an ideal solenoid is determined by both the core material and the winding or core geometry since the inductance of a coil L is where

μ₀=permeability of free space=4π×10⁻⁷ Hm⁻¹

μᵣ=core relative permeability

N=number of turns of the coil

t=core thickness (height)

w=core width

l=core length

so t w (which may be expressed as t×w)=core cross sectional area.

Magnetic flux density B=μ₀μᵣH

where for ideal solenoid

$$H = \frac{NI}{L}$$

Ultimately, for a long solenoid, the core magnetic flux density becomes:

B=μnI

where n is the turns density (number of turns per unit distance) and I is current in the coil. A magnetic material can only take a certain magnetic flux before it becomes magnetically saturated and its relative permeability dramatically drops (if the material is fully saturated then its permeability drops to 1). Therefore the relative permeability in combination with turns density of the coil and the saturation flux density determine device saturation current.

However, the magnetic field fringes towards the ends of the solenoid so the magnetic field strength H reduces near the ends. A further issue is the existence of a demagnetizing field. The demagnetizing field creates a magnetic field that is internal to the body of the core, and which acts in an opposite direction to the applied field from the solenoid. The demagnetizing field is strongest towards the ends of the core. The spatial variation of demagnetizing field can be described in terms of spatial variation of the relative permeability. Because the demagnetizing field gets stronger towards the ends of the core, the relative permeability drops towards the end and it takes higher current to magnetically saturate the ends of the core than the center of the core.

In general terms, as a solenoid gets shorter, the demagnetizing field gets stronger. Also, the magnetic fields, both applied and demagnetizing, exist in three dimensions. Thus, although the magnetic core is essentially planar it experiences some fields at its ends which are out of the plane of the planar core. This gives rise to different internal field strengths as a function of position within the magnetic core.

As a result of these factors, a ferromagnetic transformer core may suffer from early saturation of the central core area due to the uneven distribution of the magnetic flux density within the core. This onset of saturation, which grows in spatial extent as the bias current is increased, introduces early non-ideal behavior of the transformer and therefore limits the available saturation current.

FIG. 3 shows an apparatus that can be used to measure the performance of the transformer. As shown, a DC current bias 52, which could be a current source, is used to impose a DC current through the primary winding 10 of a transformer. An inductor 54 is typically included in series with the DC bias source 52 in order to present a high impedance to AC signals. An AC signal generator 56 in series with a DC blocking capacitor 58 is used to superimpose an AC signal onto the DC bias. The voltage appearing across the output of the secondary winding 30 is then measured, and then compared with the voltage provided by the AC excitation source 56. This allows the instantaneous AC power transfer of the transformer to be measured as a function of the DC bias current.

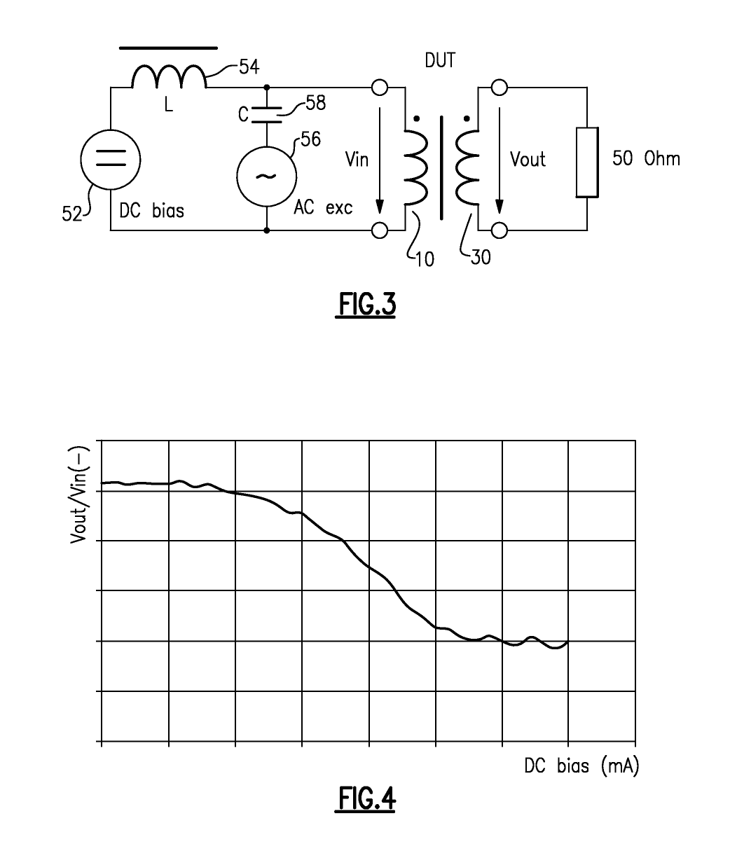

A graph illustrating measurement of this relationship is shown in FIG. 4 for a transformer with uniform windings. It can be seen that, at relatively low bias currents the ratio of a Vₒᵤₜ to Vᵢₙ, is relatively high, and can be regarded as operating the transformer in a region where its core is not saturated. Therefore the effective permeability to a small change in primary current is representative of a high value of the relative permeability μᵣ. Conversely, when the DC bias current becomes large and the core is fully saturated, the output

$$\frac{{V}_{out}}{{V}_{in}}$$

reduces to a smaller value, which is more akin to that of an air core transformer as the ferromagnetic core can no longer provide enhancement of the flux density as a result of a small change in the current.

FIG. 5 re-plots the data of FIG. 4 to show the saturated and non-saturated regions more clearly, and also to apply straight line approximations to sections of the graph.

Between the non-saturated region and the fully saturated region is a transition region, generally designated 60 where the permeability transitions from the non-saturated to the fully saturated values.

Mathematical modelling indicates that the flux density B within the ferromagnetic core is non-uniform and is weaker at the edges or ends of the core, and more intense towards the center of the core. As a result, as the DC bias current increases the central portion of the core starts to saturate, indicated in FIG. 5 by the point at which the ratio

$$\frac{{V}_{out}}{{V}_{in}}$$

starts to degrade around the area of the graph generally designated 62. The area of saturation then continues to grow from the middle to the ends until the core becomes fully saturated.

Ideally, the core transition to saturated state would start with higher bias current and it would transition more abruptly from non-saturated operation to saturated operation. This would enable a given size of magnetic core to handle more power and current before saturation occurs, although its performance would then degrade much more rapidly.

The inventor realized that steps could be taken to reduce the tendency of the central section of the magnetic core to saturate earlier than the end sections of the magnetic core. This can be achieved by a structural feature of the magnetic component, and in an embodiment this is achieved by varying the turns density of the coil as a function of distance along the coil axis.

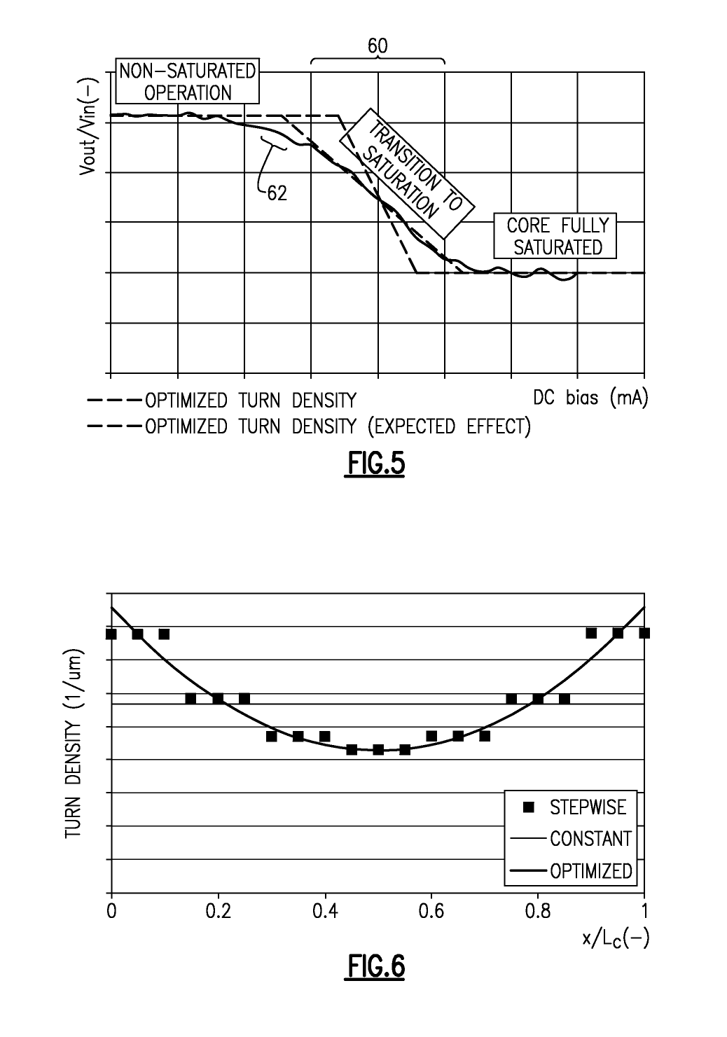

FIG. 6 is a graph schematically illustrating variation of turns density as a function of distance along a core having a length of one arbitrary unit L_{c}. It can be seen that the turns density can be increased towards the ends of the core, as represented by values of x=0 and x=1, and decreased towards the center of the core, in order to reduce the tendency for early saturation of the central section.

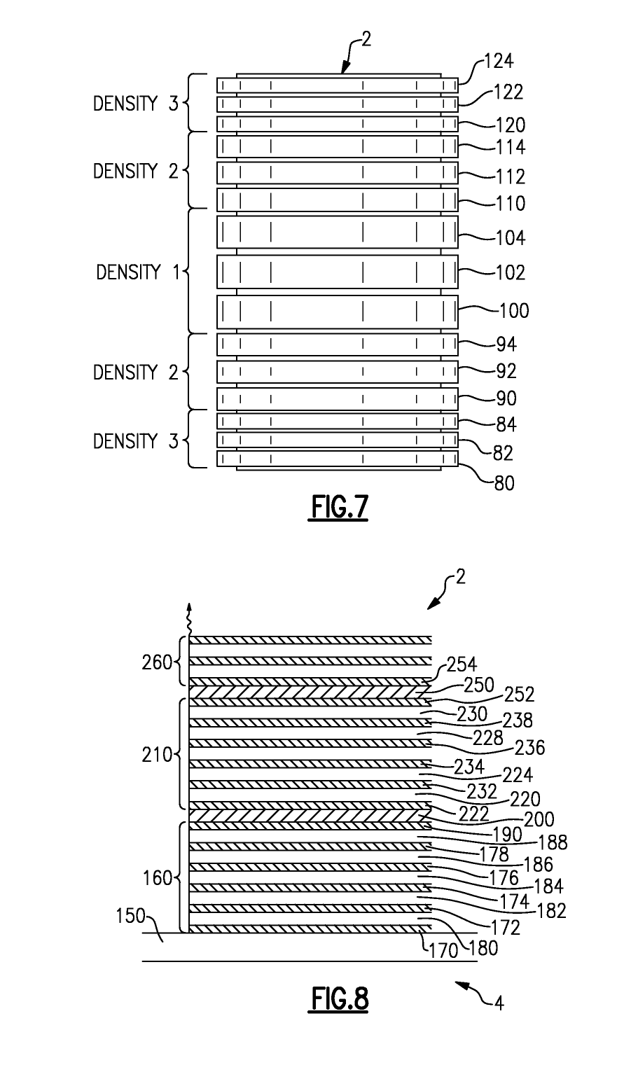

The dimensions of a coil around a magnetic core within an integrated circuit are quite compact, and it is therefore unlikely that the turns can be modified in a smoothly varying manner represented by the optimized curve in FIG. 6, but a step wise approximation is also possible as also shown in FIG. 6. As a result of applying a step wise approximation to the turns density, a winding density as shown in FIG. 7 may be achieved where the coil may be comprised of spaced apart conductors, of which only the uppermost layer is shown, but a corresponding pattern is formed on the lowermost layer beneath the core 2. The conductor strips are arranged to give a coil having a relatively low winding density, designated density 1, towards a central portion of the coil, and an intermediate winding density, designated density 2, on either side of the area at the center of the coil. Either end of the coil has a higher winding density, designated density 3, compared to the central and intermediate densities. In the illustrated embodiment, differing densities are achieved by varying the conductor widths at different sections of the coil. The first section of the coil comprises relatively wide strips of conducting material designated 100, 102 and 104 having a width w1 and an inter-conductor gap distance g1. The intermediate areas of coil density, density 2, are comprised of conductors 90, 92 and 94 having a conductor width w2 and an inter conductor gap spacing g2, and similarly for conductors 110, 112 and 114. The end portions having the highest winding density, density 3, are comprised of conductors 80, 82 and 84, and similarly conductors 120, 122 and 124, having a width to w3 and an inter conductor spacing g3.

It would be possible to vary the gap between the conductors, and keep the conductor width the same such that w1=w2=w3 and g3>g2>g1. However this arrangement, while giving generally desirable magnetic properties, can give rise to a undesirable increase in resistance of the coil compared that which could be obtained by keeping the gap between the adjacent conductors the same, such that g1=g2=g3, and then varying the relative width of the conductive elements w1, w2 and w3 such that w1>w2>w3. Varying the widths of the conductors forming the coils, rather than varying the dielectric gaps, maximizes the amount of conductor (for a given thickness of conductor) involved in carrying the current through the coil, and thereby reduces resistance.

The use of a ferromagnetic core with relatively high permeability ensures that magnetic flux generated by the primary winding 10 is efficiently coupled to the secondary winding 30.

However, as is experienced in macro-scale transformers, the magnetic flux generated around the primary winding 10 interacts with the magnetic core 2, and can give rise to eddy currents flowing within the core 2. These eddy currents flow through the resistive material of the core 2 and give rise to a loss mechanism. This reduces the efficiency of the magnetic component, and in the case of transformers may manifest itself as an apparent increase in the coil resistance of the primary and secondary windings as the excitation frequency of the primary winding increases.

Drawing on the experience of macro-scale transformers, one way to address the eddy current problem is to segment the core into a plurality of sections which are insulated from one another. Within the context of an integrated circuit, it might be thought that the easiest approach would be to form a series of trenches in the magnetic core, with the longitudinal axis of the trenches running parallel to the direction of the magnetic field generated by the windings, in which case trenches would run from the top of FIG. 1 to the bottom of FIG. 1 (Y direction) so as to divide the core into a plurality of parallel “fingers”. In fact, in the micro scale environment of integrated circuits this approach would be highly disadvantageous as the thin fingers would then exhibit shape anisotropy which would cause the magnetically easy axis of the ferromagnetic material to extend along the Y direction of FIG. 1. This in turn would give rise to large hysteretic losses within the material and low values of saturation current, which could be avoided by having the magnetically easy direction extend along the X axis (horizontally) of FIG. 1. Such an arrangement would cause the “hard” direction to be parallel with the magnetic field and the Y axis, and this direction generally has a much smaller hysteresis loop and operates in the generally linear region of the hysteresis loop over a much wider range of applied magnetic fields.

However the magnetically easy axis can be maintained along the “X” direction of FIG. 1 if the magnetic core is segmented into a plurality of individual layers, each layer existing in the X-Y plane of FIG. 1. The easy axis can be defined during deposition of the layer of magnetic material. Several techniques are known to the person skilled in the art and need not be described here.

FIG. 8 schematically illustrates a cross section through the magnetic core 2 of FIG. 1. While described below for convenience with respect to the schematic plan view of FIG. 1 and orientations set forth therein, it will be understood that the magnetic core 2 of FIG. 8 can be combined with the turns density variation of FIG. 7 and/or the core dimension variation of FIG. 10. The cross section is perpendicular to the plane of FIG. 1, showing layers stacked in the Z direction working upwards from the substrate 4. FIG. 8 is not drawn to scale and the dimensions of the component layers within the magnetic core 2 are not shown to scale with respect to each other, and neither is the size of the magnetic core 2 shown correctly to scale with respect to the rest of the integrated circuit.

As shown in FIG. 8, the substrate 4 may have one or more layers of material formed on it, generally designated 150, between the substrate 4 and a base layer of the magnetic core 2. The layer 150 may include metallic tracks forming part of the first metallic layer shown in FIG. 1 and may also include one or more layers of insulating material, such as aluminum nitride or polyimide.

The magnetic core 2 comprises a plurality of layers. In general, a first subsection, generally designated 160 of the core 2 comprises layers 170, 172, 174, 176, and 178 of the first insulating material arranged in an alternating sequence with layers 180, 182, 184, 186 and 188 of magnetically functional material. In this example five layers of magnetically functional material sit above five layers of first insulating material in an alternating stack. It should be noted that fewer, or indeed more, layers of magnetically functional material and first insulating material may be used to form the first subsection 160.

A layer 200 of the second insulating material, which can be different from the first insulating material, is formed above the first subsection 160 of the magnetic core 2. Alternatively a thicker layer of the first insulating material could be deposited. The layer 200 of second insulating material could be deposited directly onto the uppermost layer 88 of magnetically functional material in the first subsection 60. Alternatively, a barrier layer may be formed between the layer 200 of the second insulating material and the uppermost layer 188 of magnetically functional material. Such a barrier layer 190 is illustrated in FIG. 8. For convenience, the barrier layer 190 may be formed of the first insulating material. A second subsection, generally designated 210, of the magnetic core 2, comprising alternating layers of magnetically functional material and the first insulating material as described hereinbefore, is formed above the layer 200. A lowermost layer 220 of magnetically functional material could be deposited directly on to the layer 200 of the second insulating material. However, in an embodiment a layer 222 of the first insulating material is formed above the layer 200 of the second insulating material, and acts as a seed layer for the layer 220 of magnetically functional material. Thus, as shown in FIG. 8 layer 200 of the second insulating material is bounded on its upper and lower faces by layers of the first insulating material. This can have the further advantage of, for example, stopping degradation of the magnetically active material in the layers 188 and 220 occurring when, for example, the layer 200 is made out of an oxide, such as silicon dioxide.

The second subsection 210 comprises five layers of magnetically functional material 220, 224, 226, 228 and 230 with each layer of magnetically functional material being separated from an adjacent layer of magnetically functional material by a layer 232, 234, 236 and 238 of the first insulating material.

The uppermost layer of magnetically functional material 230 of the second subsection 210 is bounded by a second layer 250 of the second insulating material. As before, the layer 250 of the second insulating material may be sandwiched between layers 252 and 254 of the first insulating material. As an alternative to depositing the layer of second insulating material, a layer of first insulating material having an increased thickness (compared to layers in the subsections) could be deposited. A third subsection 260 of the core 2 is formed above the second subsection 210. This process can be continued until an uppermost portion of the magnetic core 2 is reached, where the final two layers may comprise a layer of magnetically functional material topped by a layer of the first insulating material. Thus, if the magnetic core is made of two subsections, only one layer of the second insulating material can be provided to separate the subsections. If the magnetic core is made of three subsections, then two layers of the insulating material can be provided to separate the subsections. In general it can be seen that if the magnetic core is made of N subsections, then N−1 layers of the second insulating material can be provided.

In the example given each of the subsections comprises five layers of magnetically functional material. In general, each subsection does not have to be identical to the other subsections although such an arrangement has been described here. Similarly each subsection does not need to comprise five layers of magnetically functional material. In an embodiment of a core as shown in FIG. 8, the layers of the first insulating material may be aluminum nitride (although other insulating materials such as aluminum oxide may be used for some or all of the layers of first insulating material), and have thicknesses of approximately 10 nanometers, although other thicknesses can be used and it is envisaged that the first layers could typically have a thickness range of between 5 and 30 nanometers. The magnetically active layers can be formed of nickel iron, nickel cobalt or a composite of cobalt, iron, zirconium, niobium and boron and typically have a thickness of around 100 nanometers although thinner or thicker layers, for example in the range of 50 to 200 nanometers thick may be used. The second insulating material may be arranged such that capacitive coupling between the subsections is reduced compared to capacitive coupling between adjacent layers of magnetic material in a subsection, by virtue of one or both of an increased separation between the uppermost magnetically functional layer of one subsection, and the lowermost magnetically functional layer of the next subsection, and reduced permittivity of the second insulating material relative to the first insulating material.

Aluminum nitride has a relative permittivity of about 8.5, whereas as silicon dioxide has a relative permittivity of about 3.9. Accordingly, in one embodiment the first insulating material is aluminum nitride and the second insulating material is silicon dioxide.

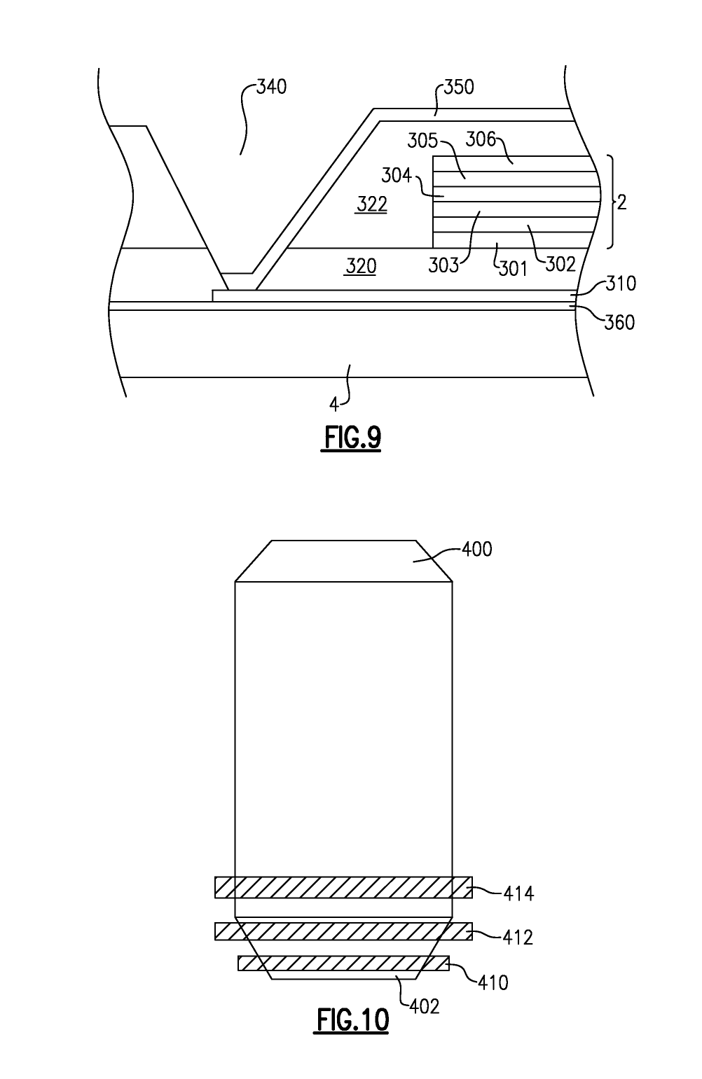

FIG. 9 is a schematic cross section through an integrated circuit including a transformer having a magnetic core, generally indicated by reference numeral 2, constituting an embodiment of the invention. The magnetic core 2 shown in FIG. 8 is divided into six subsections 301 to 306 by intervening layers of the second insulating material. Each subsection is, as before, comprised of alternating layers of the first insulating material and magnetically functional material.

As shown in FIG. 9, the integrated circuit comprises a substrate 4 which has a lowermost metallic layer 310 deposited thereon. After deposition, the metallic layer 310 is masked and etched so as to form conductive tracks, some of which act to form tracks 14, 18, 32 and 36 of FIG. 1 which constitute part of the primary and secondary windings 10, 30. As noted with respect to FIG. 8, while reference is made to the schematic plan view of FIG. 1, it will be understood that the structure of FIG. 9 can be combined with the turns density variation described with respect to FIG. 7 and/or the core profile variations described below with respect to FIG. 10. An insulating layer 320, for example of polyimide, is then deposited above the metal layer 310 to insulate the magnetic core from the transformer windings. The transformer layers 301-306 are then deposited, for example by deposition across the entirety of the substrate. The structure is then masked and then etched so as to form isolated transformer core regions above the insulating layer 320. Additional insulating material may then be deposited to fill in the gaps between adjacent transformer cores 2 on the substrate 4 and to overlie the cores to encapsulate them within a dielectric. Such an insulating layer is designated as 322 in FIG. 9. The insulating layer 322 may then be subject to planarizing in order to form a substantially flat upper surface of the integrated circuit. This surface may then be masked and etched in order to form depressions 340 in the insulating layer 322 and layer 320 which extend down to the lowermost metallic layer 310. The upper surface may then have a metallic layer 350 deposited on it. The metal also deposits into the V shaped depressions 340 thereby forming interconnections between the lowermost metallic layer 310 and the uppermost metallic layer 350. The layer 350 can then be masked and etched in order to form, amongst other things, the conductive tracks 12, 16, 34 and 38 shown in FIG. 1 constituting parts of the primary and secondary windings 10, 30.

The lowermost metallic layer 310 may be formed over an insulating layer 360 for example of silicon dioxide, which may itself overlie various semiconductor devices (not shown) formed by implantation of donor or acceptor impurities into the substrate 4. As known to the person skilled in the art, apertures may be formed in the insulating layer 360 prior to depositing the first metallic layer 310 in order to form device interconnections among the various circuit components.

As well as varying the turns density within the transformer it is also possible to modify the flux density within the core by varying the shape of the core. These approaches can be used separately or in combination. Thus, as shown in FIG. 10 the rectangular magnetic core 2 of FIG. 1 can be modified to have tapered sections 400 and 402 at end portions of the magnetic core so as to reduce the width of the magnetic core at its ends. The relative diameter of the winding formed by the conductive elements may also vary to conform to that of the core, schematically represented by conductive tracks 410, 412 and 414 where tracks 410 is shorter than track 412, and track 412 is shorter than track 414. Profiling need not be performed to the entirety of the core where the core is formed of separate layers, as discussed with respect to FIGS. 8 and 9, but profiling may be performed on some layers and not the others. Furthermore, the spatial extent of the layers may also be varied such that the vertical height of the magnetic core may vary such that, for example, the center of the core has a greater vertical height than the ends of the core. This can be achieved by changing the relative spatial extents of some of the layers which are used to form the core when the core is provided as a laminated structure.

It is thus possible to form an improved magnetic component, such as an inductor or a transformer within an integrated circuit. The substrate carrying the magnetic component and other components can be packaged in a chip scale (integrated circuit) package as known to the person skilled in the art.

Although the claims presented here are in single dependency format for filing at the USPTO, it is to be understood that any claim may depend on any preceding claim of the same type except when that is clearly not technically feasible.

What is claimed is:

1. An inductive component for use in an integrated circuit, comprising:
a magnetic core;
a plurality of conductors arranged on a first side of the magnetic core;
a plurality of conductors arranged on a second side of the magnetic core;
a plurality of conductive connections connecting selected one of the first plurality of conductors to selected ones of the second plurality of conductors of the second plurality so as to form a first coil, and a compensation structure for compensating for core saturation non-uniformity.

2. An inductive component as claimed in claim 1, where the compensation structure comprises a non-uniform coil.

3. An inductive component as claimed in claim 1, where the conductors form a coil, and a turns density of the coil varies as a function of position along a coil axis.

4. An inductive component as claimed in claim 3, in which the turns density is reduced with increasing distance from an end of the magnetic core along the coil axis.

5. An inductive component as claimed in claim 2, in which a conductor width increases with increasing distance from an end of the magnetic core along a coil axis.

6. An inductive component as claimed in claim 1, in which a width of the coil varies with distance along a coil axis.

7. An inductive component as claimed in claim 1, in which the compensation structure comprises a non-rectangular magnetic core.

8. An inductive component as claimed in claim 1, in which the width of the core varies as a function of position along a coil axis.

9. An inductive component as claimed in claim 1, in which the thickness of the core varies as a function of position.

10. An inductive component as claimed in claim 1, in which the core is formed from a plurality of layers, and one of the shape or composition of at least one of the layers is varied.

11. An inductive component as claimed in claim 1, which the component is an inductor.

12. An inductive component as claimed in claim 1 in which the component is a transformer.

13. An inductive component as claimed in claim 12, further comprising a second coil magnetically coupled with the magnetic core.

14. An inductive component as claimed in claim 12, in which the second coil has a spatial varying turns density.

15. An integrated circuit including the inductive component as claimed in claim 1.

16. A monolithic integrated circuit including the inductive component as claimed in claim 1.

17. A method of forming a magnetic component comprising depositing a first plurality of conductors on a substrate; forming an insulator between and above the plurality of conductors; forming a magnetic core above the insulator; forming an insulating layer above the magnetic core; forming a plurality of conductors above the insulating layer; and forming electrical interconnections between the first plurality of conductors and the second plurality of the conductors in an interconnect pattern so as to form a coil around the magnetic core, where at least one of the magnetic core or a winding formed by the conductors is spatially non-linear along a coil axis.

18. A method as claimed in claim 17, in which the coil is formed such that it has a turns density that is lower away from the ends of the magnetic core compared to a turns density at the ends of the magnetic core along the coil axis.

19. A method as claimed in claim 18, in which the shape of the magnetic core is modified such that it is wider or thicker at a portion distal to the ends of the core compared to an end portion of the core.

20. An integrated circuit including an inductive component formed from spaced apart conductive tracks in different metal layers of the integrated circuit and connected so as to approximate a coil, wherein an instantaneous turns density varies along a coil axis between an end of the coil and a center of the coil.
